(19) United States
(12) Patent Application Publication
(10) Pub. No.: US 2015/0022124 A1
(43) Pub. Date: Jan. 22, 2015

(54) Self Sustainable Automobile

(71) Applicant: Patrick Eziuwa Nwosa, New York, NY (US)

(72) Inventor: Patrick Eziuwa Nwosa, New York, NY (US)

(21) Appl. No.: 13/944,307

(22) Filed: Jul. 17, 2013

(51) Int. Cl. B60L 11/18

(52) U.S. Cl. CPC B60L 11/1809; B60L 11/1877; Y10S 74/09; H02K 53/00
USPC 318/139; 74/DIG. 9

(57) ABSTRACT

A self-sustainable automobile is disclosed in the present invention. Said self-sustainable automobile uses chargeable batteries as its power source. The motor and chargeable batteries is matched in such a way that the time for fully charging the batteries is faster than the time for fully discharging the batteries. Thus engine requires no external source of energy to be or remain in motion.

### BACKGROUND OF THE INVENTION

### Field of the Invention

The present invention relates to an automobile, and more particularly, an electronic automobile that uses chargeable batteries as its power source.

Recently, concern over the environmental impact of fossil fuel-based transportation infrastructure has led to greater interest in electric vehicles. An electric vehicle is a vehicle that uses one or more electric motors for propulsion. Electric power has remained common in some vehicle types, such as trains and streetcars, but for automobiles, internal combustion engine has become the main propulsion mechanism.

There are efforts to build electronic automobiles using electricity as power source. For example, now on the market there are Hybrid automobiles. These automobiles have chargeable batteries and use electricity from these batteries as power source at some time. The major problem with current electronic automobile is that the batteries need to be charged by external power source. For example, in the Hybrid automobiles, they still need fossil fuel combustion to provide the external power to set the automobile in motion than be able to charge the batteries. There are also other types of electronic automobiles that need to plug the batteries into an electric outlet to charge the batteries. Combustion of fossil fuel to charge batteries or using external electricity to charge batteries still cannot finally resolve the environmental concerns. Not to mention that fossil fuel itself cause big environmental problems, we still depend a lot on combustion of fossil fuel to generate electricity.

### SUMMARY OF THE INVENTION

In an exemplary embodiment of the present invention, there is disclosed a self-sustainable automobile 10 comprising of a DC shunt motor, a charge controller, a battery bank, a resistance stud, cablings, self-excited AC motor, a power electronic converter, an electronic controller, a plurality of batteries, a battery charger, a motor differential unit, a plurality of wheels, and a user input unit. Said self-sustainable automobile uses chargeable batteries as its power source. The motor and chargeable batteries is matched in such a way that the time for fully charging the batteries is faster than the time for fully discharging the batteries. Thus engine requires no external source of energy to be or remain in motion.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a schematic figure of the components of the preferred embodiment of the present invention.

### DESCRIPTION OF THE PREFERRED EMBODIMENT

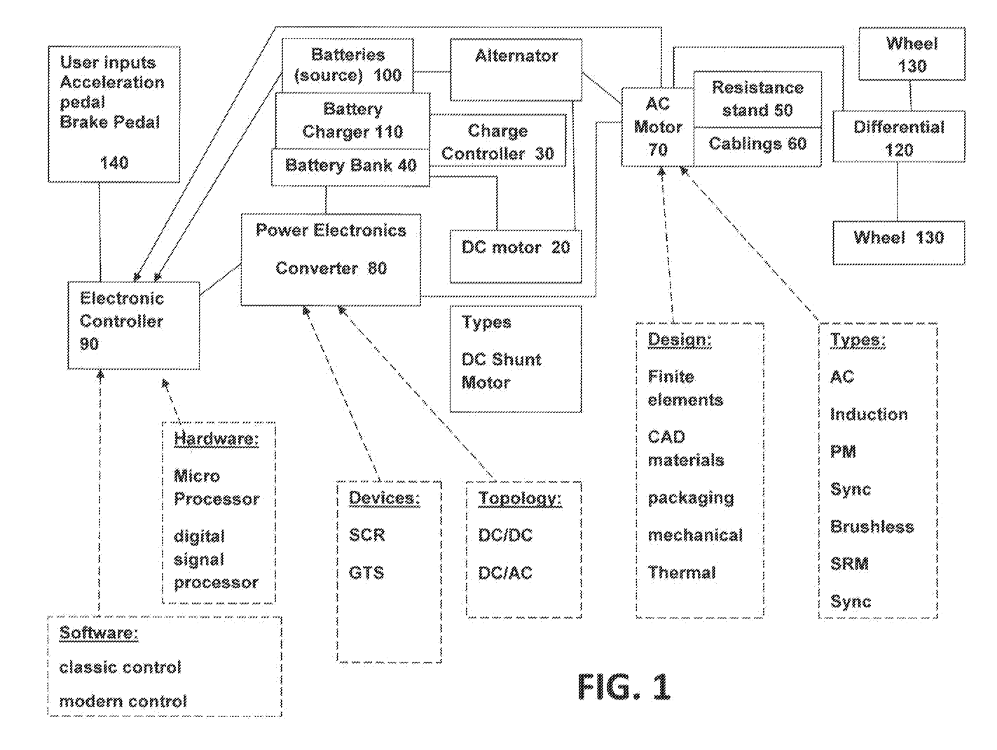

Referring to FIG. 1, there is disclosed a self-sustainable automobile comprising of a DC shunt motor 20, a charge controller 30, a battery bank 40, a resistance stud 50, cablings 60, self-excited AC motor 70, a power electronic converter 80, an electronic controller 90, a plurality of batteries 100, a battery charger 110, a motor differential unit 120, a plurality of wheels 130, and a user input unit 140; wherein batteries of said self-sustainable automobile charge faster than they are being discharged therefore the batteries remains constantly charged.

In one preferred embodiment of the present invention, the battery bank comprising of three deep cycle batteries rated 12 volt, 100 Ah at 20 hours. In the same preferred embodiment, the DC motor is rated 2 hp, 36 volt, and the charge controller rated maximum input voltage of 150 Vdc, maximum input and output currents 45 A dc, range of operating voltage of 10-72 Vdc, and maximum ambient temperature of 45° C.; and said charge controller regulates battery charges to a required amount without overcharging and ensures delivering a required power to the motor.

The present invention is a self-sustainable automobile, based on the following calculations:

1. discharging time of the battery: since the DC motor is rated 2 hp, 36 volt

The power of the motor: 2 hp=2*746=1492 (Watts)

Current drawn by motor: I=Power/Voltage=1492/36=41.44 (amp)

Time required to discharge the battery=battery rating in AH/current drawn by motor=100/41.11=2.41 hours=2 hours, 24 minutes, 36 seconds.

2. charging time of the battery is calculated using this formula:

MTFC=(BC/CRC)*EF
whereas MTFC=maximum time to full charge;
BC=battery capacity=100 Ah 8 3=300 Ah;
CRC=charge rate current=200 Ah;
EF=efficiency factor=100/100 (operating with no efficiency loss);
   110/100 (operating with 10% efficiency loss);
   120/100 (operating with 20% efficiency loss);
   130/100 (operating with 30% efficiency loss);
   140/100 (operating with 40% efficiency loss).

Thus:

MTFC (no efficiency loss)=(300/200)*100/100=1.5 hours;

MTFC (10% efficiency loss)=(300/200)*110/100=1.65 hours;

MTFC (20% efficiency loss)=(300/200)*120/100=1.8 hours;

MTFC (10% efficiency loss)=(300/200)*110/100=1.95 hours;

MTFC (10% efficiency loss)=(300/200)*110/100=2.1 hours.

From the above calculation, the maximum time to full charge of the batteries, even under a 40% efficiency loss rate, is shorter than the time required to fully discharge the batteries (2.1 hours, 2.41 hours). So the battery charges faster than it is being discharged therefore the battery remains constantly charged. then engine requires no external source of energy to be or remain in motion.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A self-sustainable automobile, comprising:
a DC shunt motor;
a charge controller;
a battery bank
a resistance stud;
cablings;
a self-excited AC motor;
a power electronic converter;
an electronic controller
a plurality of batteries
a battery charger;
a motor differential unit;
a plurality of wheels; and
a user input unit;
wherein the batteries of said self-sustainable automobile charge faster than they are being discharged therefore the batteries remains constantly charged.

2. A self-sustainable automobile of claim 1, wherein said battery bank comprising of three 12 volts, 100 AH accumulators connected in series configuration.

3. A self-sustainable automobile of claim 2, wherein said resistance stud consisting of four studs for speed variation.

4. A self-sustainable automobile of claim 3, wherein said charger controller is rated maximum input voltage of 150 Vdc, maximum input and output currents 45 A dc, range of operating voltage of 10-72 Vdc, and maximum ambient temperature of 45° C.; wherein said charge controller regulating battery charges to a required amount without overcharging and delivering a required power to the motor.

5. A self-sustainable automobile of claim 4, wherein said DC motor is rated 2 hp, 36 volt.

6. A self-sustainable automobile, comprising:
a DC shunt motor rated 2 hp, 36 volt;
a charge controller rated maximum input voltage of 150 Vdc, maximum input and output currents 45 A dc, range of operating voltage of 10-72 Vdc, and maximum ambient temperature of 45° C.; wherein said charge controller regulating battery charges to a required amount without overcharging and delivering a required power to the motor;
a battery bank comprising of three deep cycle batteries rated 12 volts, 100 AH at 20 hours accumulators connected in series configuration;
a resistance stud consisting of four studs for speed variation
cablings;
a self-excited AC motor;
a power electronic converter;
an electronic controller
a plurality of batteries
a battery charger;
a motor differential unit;
a plurality of wheels; and
a user input unit;
wherein the batteries of said self-sustainable automobile charge faster than they are being discharged therefore the batteries remains constantly charged.
